(19) United States
(12) Patent Application Publication
(10) Pub. No.: US 2011/0079942 A1
(43) Pub. Date: Apr. 7, 2011

(54) ISOLATION SYSTEM FOR REDUCED VIBRATIONS IN A VEHICLE INTERIOR

(76) Inventor: James W. Post, II, Dublin, OH (US)

(21) Appl. No.: 12/572,456

(22) Filed: Oct. 2, 2009

(51) Int. Cl. F16M 1/08; B60N 3/00; B23P 11/00

(52) U.S. Cl. 267/136; 296/193.04; 29/428

(57) ABSTRACT

A vibration isolation scheme includes an interior sled mounted to a vehicle body by one or more sled isolators having damping properties. The sled floats with respect to the vehicle body to isolate vehicle occupants from vibrations otherwise transmitted from the vehicle body. The sled isolators can be located at specific vibrational nodes to target a particular frequency or a range of frequencies. The damping properties of the sled isolators can attenuate vibrations in ranges outside the target frequencies.

### I. BACKGROUND

A. Field of Invention

This invention relates to isolation systems for reducing vehicle vibrations. More particularly, this invention relates to a vibration isolation system for isolating a vehicle interior from the body of the vehicle.

B. Description of the Related Art

It is known in the art to isolate various noise and vibration disturbances from occupants of motor vehicles in order to reduce fatigue and improve riding comfort. The field of measuring and modifying vibration and noise characteristics of vehicles is sometimes referred to as noise, vibration, and harshness (NVH). Vibration disturbances come from a number of sources, including road inputs from contact between the tires and the ground, engine vibration from idling and aftershake from running over bumps, etc., along with transient aerodynamic wind forces. A number of currently available vibration isolation schemes are illustrated in FIGS. 1, 2, and 3.

FIG. 1 depicts a “body-on-frame” scheme 10 for isolation of road inputs from the front wheel 12a and the rear wheel 12b to the frame 14, and from the frame 14 to the body 16. With the body-on-frame approach, wheel to frame isolation components 20 are placed at the front wheel 12a and rear wheel 12b, and cooperate with one or more frame to body isolation components 22, thus providing essentially one-dimensional filtering of specific frequencies without significantly influencing low frequency behaviors of ride comfort and handling/steering response characteristics. Thus, the body-on-frame scheme 10 provides a beneficial level of isolation.

The body-on-frame scheme 10 of FIG. 1 also provides isolation for engine vibration with a drivetrain-to-frame isolation system that cooperates with the frame to body isolation component 22. Similarly to the, above wheel/frame and frame/body isolation components 20, 22 of the body-on-frame scheme, the drivetrain-to-frame isolation system can be used to control engine motion and manage load. The drivetrain-to-frame isolation system can include an engine mount isolation component 24 for isolating the engine 24a from vibration of the frame 14. A transmission isolation component 26 isolates the transmission 26a from the frame 14. Similarly, a drive axle isolation component 28 isolates the drive axle 28a from the frame 14. The frame to body isolation component 22 cooperates with the drivetrain-to-frame isolation system components 24, 26, 28 to provide isolation for mid-high frequency vibrations from the drivetrain components 24a, 26a, 28a.

FIG. 2 shows a “unibody” or “monocoque” isolation scheme 30 where the vehicle frame and body 16 are made as one piece, and a front subframe 14a and a rear subframe 14b are placed at the front and rear axle areas to provide additional sources of isolation. In the unibody isolation scheme 30, road input isolation is provided at the front wheel 12a and the front subframe 14a using a front wheel to front subframe isolation component 20a. Road input isolation is provided at the rear wheel 12b and rear subframe 14b with a rear wheel to rear subframe isolation component 20b.

As shown in FIG. 2, the aforementioned front and rear wheel to subframe isolation components 20a, 20b cooperate with respective front and rear subframe to body isolation components 22a, 22b to provide isolation along those respective vibration paths. The front and rear subframe to body isolation components 22a, 22b also support lateral and longitudinal loading to ensure handling and stability characteristics. However, this imposes additional constraints on the design and implementation of the front and rear subframe to body isolation components 22a, 22b.

In the unibody isolation scheme 30 of FIG. 2, drivetrain vibration isolation in a typical unibody construction includes a direct connection between the drivetrain components 24a, 26a, 28a and the body 16 as well as a connection 24, 26, 28 between the drivetrain components 24a, 26a, 28a and the front and rear subframes 14a, 14b. To this end, a drivetrain-to-front-subframe isolation system and a drivetrain-to-rear-subframe isolation system are provided that cooperate with respective front frame to body isolation components 22a and rear frame to body isolation components 22b.

As also shown in FIG. 2, the drivetrain-to-front-subframe isolation system can include the engine mount isolation component 24 for isolating the engine 24a from the front subframe 14a and also the transmission isolation component 26 for isolating the transmission 26a from the front subframe 14a. Similarly, the drivetrain-to-rear-subframe isolation system can include the drive axle isolation component 28 to isolate the drive axle 28a from the rear subframe 14b. The front subframe to body isolation component 22a and the rear subframe to body isolation component 22b cooperate with the drivetrain-to-subframe isolation systems to provide isolation for mid-high frequency vibrations from the drivetrain components 24a, 26a, 28a. Additional vibration isolation is provided by an engine to body isolation component 32.

The engine to front subframe isolation system shown in FIG. 2 reduces engine vibration or aftershake vibration from ride impact events. The front subframe to body isolation component 22a utilizes the same isolation scheme as that used to provide road input isolation, which can include bushings and/or mounts. There are a number of constraints and trade-offs in the design and manufacture of the subframe to body isolation systems requiring manufacturers to devote considerable design energy and resources to optimize this system.

In both the body-on-frame and unibody schemes shown in FIG. 1 and FIG. 2, body to seat isolation components 34 can also be provided for vibration isolation of occupant seats 34a. Typically, a seat frame rail is bolted to the body 16, 16a to provide sufficient strength requirements for crash worthiness and the seat isolation components 34 can include foam components, springs or other components of the seat. This approach has some effectiveness in attenuating vibration energy to the occupants, but only in the seat area. The occupant can also receive vibrations by touching other parts of the vehicle body such as the floor area, the door (e.g., a side arm rest) and the center console area between the two front seats (including an aim rest). Hence, typical seat isolation components 34 have limited value in reducing vibration.

FIG. 3 depicts a vibration isolation scheme 40 as applied to heavy truck vehicles. This heavy truck isolation scheme 40 is similar to the body-on-frame technology of FIG. 1, and includes isolation components 20, 22, 24, 26, 28, 34. However, a truck is typically longer than an automobile. Thus, vertical deflection of the frame 14 under the cabin area of the body 16 can occur, causing additional motions to the driver and occupants. Hence a body-to-frame isolation system for this scheme 40 includes additional components compared to that of the body-to-frame isolation of the passenger car concept. For example, in order to reduce larger motions of the truck's body 16 with respect to the frame 14, dampers or even springs can be implemented to deal with specific low frequency motions (1-3 Hz).

The body to seat isolation components 34 shown in FIG. 3 for reducing vibration to the seats 34a are generally designed to reduce bothersome vertical vibration caused by movement of the body 16 on the frame 14 and also from deflection of the frame 14. Both the body to frame isolation components 22 and the body to seat isolation components 34 must also sufficiently attenuate mid and high frequency vibration in order to create an environment that is sufficiently comfortable for long hours of operation.

In order to provide vibration isolation, the various components in the vehicle isolation systems, namely the wheel to subframe, subframe to body, engine to subframe and body to seat isolation systems must typically be designed to include isolation features. However, this can result in reduced design freedom and consequently a performance penalty for vibration isolation designs. For example, to improve isolation, wheel to subframe bushings might not be designed for optimal wheel motion control or durability, and vibration isolation can result in compromises in handling and stability and/or higher cost.

The three representative structures shown in FIGS. 1, 2, and 3 each entail a compromise between vibration isolation (e.g., attenuation of mid to high frequency vibrations) and allowance of low frequency vibrations, in order to insure ride comfort and vehicle handling, for example. Such concerns are especially applicable to unibody constructions, which have numerous requirements for subframe to body isolation while allowing sufficient performance for NVH considerations, ride comfort, and handling/stability.

What is needed is an isolation system that provides for decoupling of the requirements of specific isolation components while allowing low frequency motions, thereby enabling the isolation components to be designed more simply while improving overall performance.

### II. SUMMARY

According to one aspect of the present invention, a new and improved vibration-isolation system for a vehicle includes an interior sled and at least one sled isolator. The interior sled has a floor portion defining a seat-mounting area adapted to support a plurality of seats within an interior defined by a vehicle body. The sled isolator is connected to the interior sled and to the vehicle body and has a damping property for isolating the interior sled from vibrations of the vehicle body.

According to another aspect of the present invention, a vehicle includes a vehicle body, a plurality of seats for supporting vehicle occupants, a sled structure located within an interior defined by the body, and at least one sled isolator connected to the sled structure and the body. The sled structure includes a floor portion to which the seats are mounted and the sled isolator has a damping property such that the sled structure and the seat are isolated from vibrations of the vehicle body.

According to another aspect of the present invention, a method of constructing a vibration-isolated vehicle includes analyzing a vehicle body design to locate nodes of vibration. The method also includes connecting one or more isolator components to the vehicle body at locations corresponding to a node of vibration. The method additionally includes connecting an interior sled to the at least one isolator component so as to isolate the interior sled from vibrations of the vehicle body.

One advantage of this invention is that superior vibration isolation is provided compared to prior systems.

Another advantage of this invention is that design considerations for vibration isolation can be decoupled from performance related design considerations.

Another additional advantage of this invention is that it reduces the number and complexity of vibration isolation components.

Still another advantage of this invention is that it allows greater protection for the vehicle occupants from large accelerations (i.e., high-g spikes) during a collision.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, exemplary embodiments of which will be described in detail in this specification and illustrated in the accompanying drawings which form a part hereof and wherein:

FIG. 1 is a side view of a vehicle showing a prior art body-on-frame vibration isolation scheme.

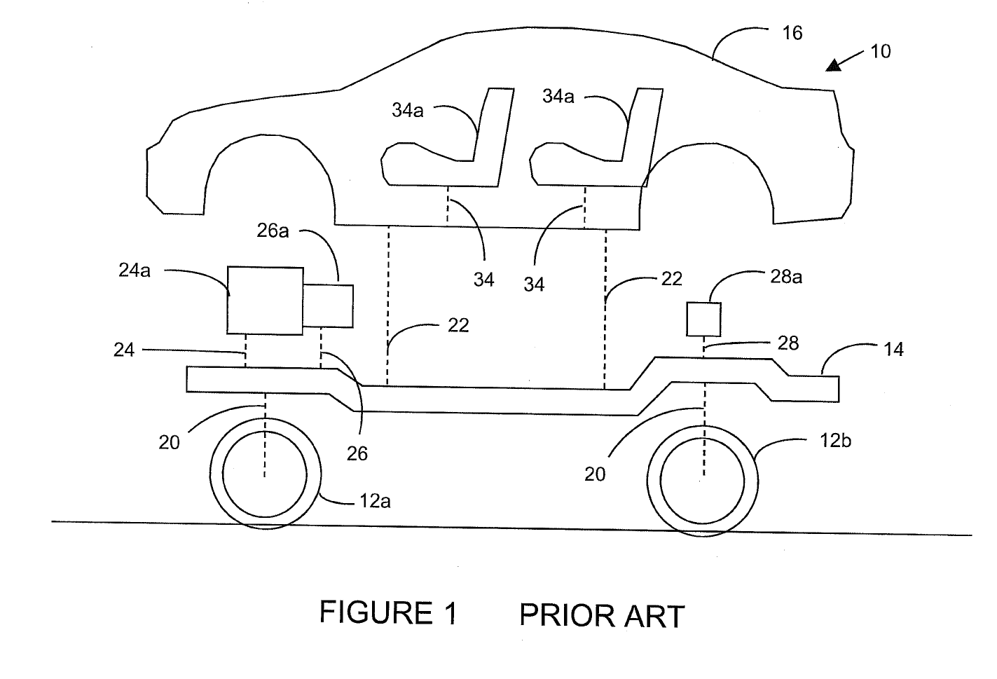

FIG. 2 is a side view of a vehicle showing a prior art unibody vibration isolation scheme.

FIG. 3 is a side view of a vehicle showing a prior art body-on-frame vibration isolation scheme as applied to a heavy truck.

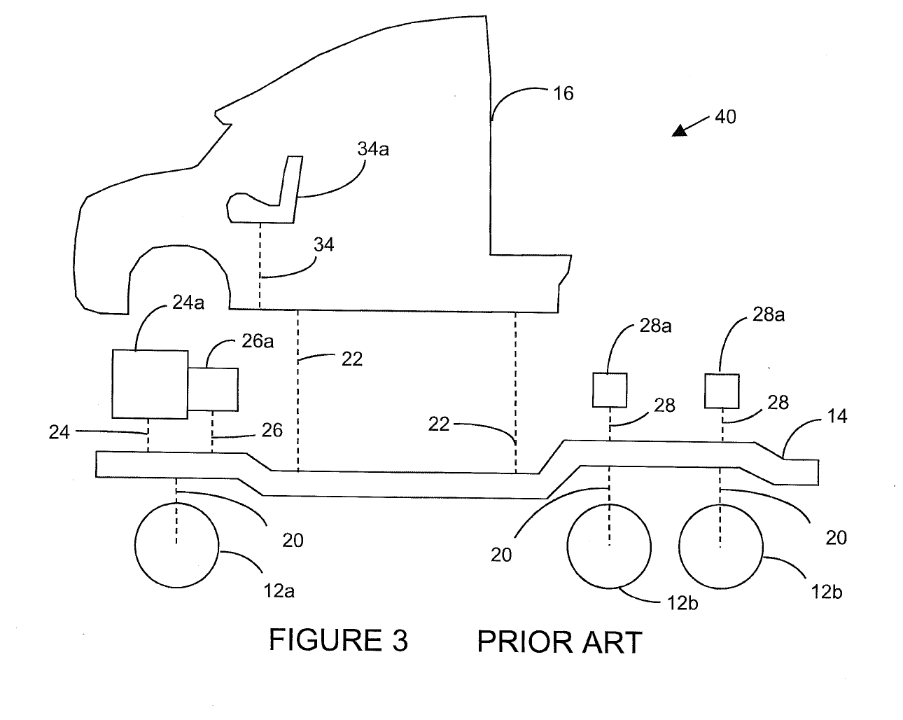

FIG. 4 is a side view of a vehicle showing an isolation scheme for a floating interior in accordance with an exemplary embodiment.

FIG. 5 is a side view of a vehicle showing a modified isolation scheme for a floating interior in accordance with an alternative exemplary embodiment.

FIG. 6 is a flow chart depicting a method of construction for a vibration-isolated vehicle in accordance with an exemplary embodiment.

### IV. DETAILED DESCRIPTION

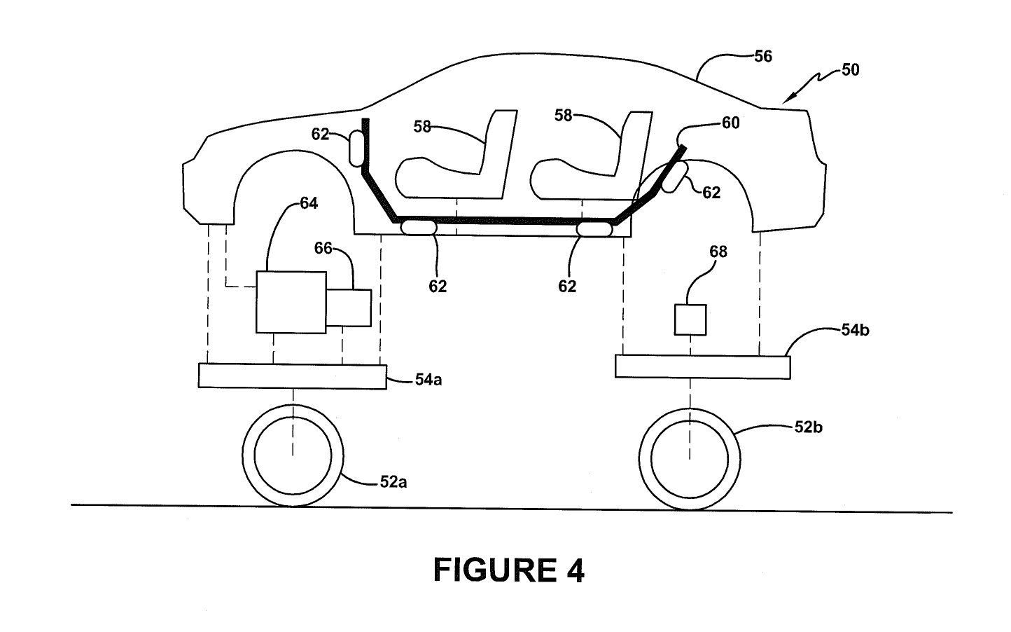

Referring now to the drawings wherein the showings are for purposes of illustrating exemplary embodiments of the invention only and not for purposes of limiting the same, FIG. 4 shows a floating interior vibration isolation scheme 50 for a vehicle, particularly useful for a vehicle having a unibody construction. The scheme 50 provides connectivity of a front wheel 52a and a rear wheel 52b respectively to a front subframe 54a and a rear subframe 54b, and from the front and rear subframes 54a, 54b to a vehicle body 56 such that load paths between road inputs and the vehicle body 56 are defined.

The vehicle body 56 includes a passenger compartment adapted to receive a number of vehicle occupants, including a driver and one or more passengers, in a number of vehicle seats 58. The vehicle body 56 receives vibrations produced and transmitted throughout the vehicle, through the wheels 52a, 52b and also one or more frame portions, such as the subframes 54a, 54b.

An interior sled 60 is provided within the vehicle body 56. The interior sled 60 is a structural component mounted inside the unibody structure and defining an interior cabin area for retaining the seats 58 of the driver and passengers of the vehicle. The interior sled 60 defines a floor portion to which the seats 58 are mounted and front and rear wall portions of the interior cabin area.

As indicated in FIG. 4, the interior sled 60 cooperates with one or more sled isolators 62, each of which define an attachment point between the interior sled 60 and the vehicle body 56. The sled isolators 62 are adapted to attenuate (e.g., by resilient mounts, damping structures, etc.) vibrations transmitted throughout the vehicle from the wheels 52a, 52b to the vehicle body 56. In this way, the interior sled 60 separates the interior cabin area from other vehicle components thereby isolating the vehicle occupants from body vibrations that would otherwise be transmitted. In this manner, the support of the sled 60 by the sled isolators 62 can be understood as providing a “floating” structure on which the seats 58 are mounted.

The sled isolators 62 can be attached to the vehicle body 56 at locations well suited for attenuating vibrations. Like all physical bodies, the vehicle body 56 has natural frequencies of vibration (e.g., resonance modes) over the surface of the vehicle body 56, whether the vehicle has a body-on-frame or unibody construction. For these body vibrations, there are generally a number of resonance modes in the range of 20 Hz-1 kHz which have little to no damping, since structures of steel, aluminum or other metals have poor damping characteristics.

Design and optimization of vehicle body structures with respect to vibration control typically entails either locating modal frequencies to areas on the body where they are less bothersome or locating the modal points of the body such that they do not negatively coincide with seat frame rail connection points or areas of the floor where occupants commonly place their feet or hands. Alternatively, thick isolation pads can be used (e.g., melt sheets, etc.) applied to the floor of the vehicle to add mass and hence damping to the modal vibrations of the floor, sidepanels, roof etc. of the vehicle body. These measures are generally costly, add weight to the vehicle.

The floating interior sled 60 and the placement of the sled isolators 62 can be designed to accommodate a set of modal characteristics for the vehicle body 56. An analysis of the design of the vehicle body 56 can be performed to locate the most significant vibrational motions (e.g., vibrational modes representing points of highest amplitude for a particular vibrational frequency), nodes (i.e., points of lowest amplitude for a particular vibrational frequency), modal frequencies, etc. Such information can then be used to establish connection points for the sled isolators 62 and the vehicle body 56.

The sled isolators 62 can be placed between the sled 60 and the body 56 at locations where out-of-plane body vibrations at the target frequency are minimal (i.e. the vibrational nodes) in order to isolate the body vibration frequency. In this way, frequency ranges of vibration can be targeted for attenuation since minimal vibration will occur at such locations selected for the sled isolators 62. Spacing between the sled 60 and the vehicle body 56 insures that no contact occurs between the sled 60 and the vehicle body 56 corresponding to the modes of highest amplitude out-of-plane motion.

Since modes and nodes of different vibrational frequencies are located at different locations on the vehicle body 56, the sled isolators 62 can be designed to attenuate other frequency ranges not associated with the node to which they are attached. To this end, the sled isolators 62 can have a damping component that attenuates frequency ranges outside the resonant frequencies of the body. The sled isolators 62 can comprise a material having damping properties (e.g., an elastic rubber material, a highly viscous liquid, or a flexible foam). It is to be appreciated that any suitable material or discrete physical subcomponent can also be used to provide damping properties in the sled isolators 62.

By locating the sled isolators 62 at vibrational nodes, and by forming the sled isolators 62 to have damping properties, two levels of vibration attenuation can be accomplished by exploiting the geometry of the sled-to-body connection and the design of the mounting system itself. For example, as shown in FIG. 4, one or more of the sled isolators 62 can be attached to one or more locations on the vehicle body 56. The connection locations for the sled 60 can include, for example, the floor area, the B-pillar base, the rear cross-member area, or even the firewall.

The interior sled 60 houses the components of the vehicle interior cabin conventionally mounted to the main vehicle body. In this way, isolation is provided to most areas contacted by occupants during vehicle operation. Thus, the interior area defined by the sled 60 becomes a highly isolated area. In this way, noise, vibration and harshness (NVH) considerations can be decoupled from the design constraints of the vehicle components along a vibrational path from the wheels 52a, 52b to the vehicle interior cabin.

By decoupling design constraints in the aforementioned manner, the design and configuration of the interior sled 60 provides vibration isolation so that other systems within the vehicle (e.g., the wheel-to-subframe, subframe-to-body, engine-to-subframe and sled-to-seat systems) can be designed for performance considerations rather than vibration isolation. To this end, one or more vibration-producing vehicle components can be connected to the vehicle such that vibrations are attenuated by the interior sled 60, without providing additional isolation components specific for each system. Such vibration-producing vehicle components can include, for example, the front and rear subframes 54a, 54b, the vehicle wheels 52a, 52b, the engine 64, the transmission 66, and the drive axle 68.

A particular example of the design freedoms enabled by the above-described vibration isolation scheme 50 follows. In order to achieve improvements in handling and stability, the vehicle can include wheel-to-subframe bushings designed specifically for precise wheel motion control without the constraints of vibration attenuation requirements associated with conventional unibody systems. In addition, the bushings that mount the subframe to the body can also be designed based on durability, cost and other important factors. Such freedom in the design of these parts can be used to improve other performance factors which are normally compromised due to the current requirements for limiting vibration through these components.

Additional performance benefits obtained from the floating interior sled 60 relate to crash worthiness. In current vehicle designs, interior occupant protection represents a compromise between the reduction of body intrusion and the smooth management of impact energy during a collision. The mounting structure of the interior sled 60 provides a degree of movement to the sled 60 resulting in additional stroke that attenuates large accelerations (i.e., (high g-spikes) during crash events. The additional stroke of the mounting structure can be either one or both of a longitudinal stroke and a lateral stroke with respect to the vehicle body. Additionally, the mounting system can provide damping of low frequency vibrations in the interior during a crash, thus reducing g-spike characteristics of the crash dynamics.

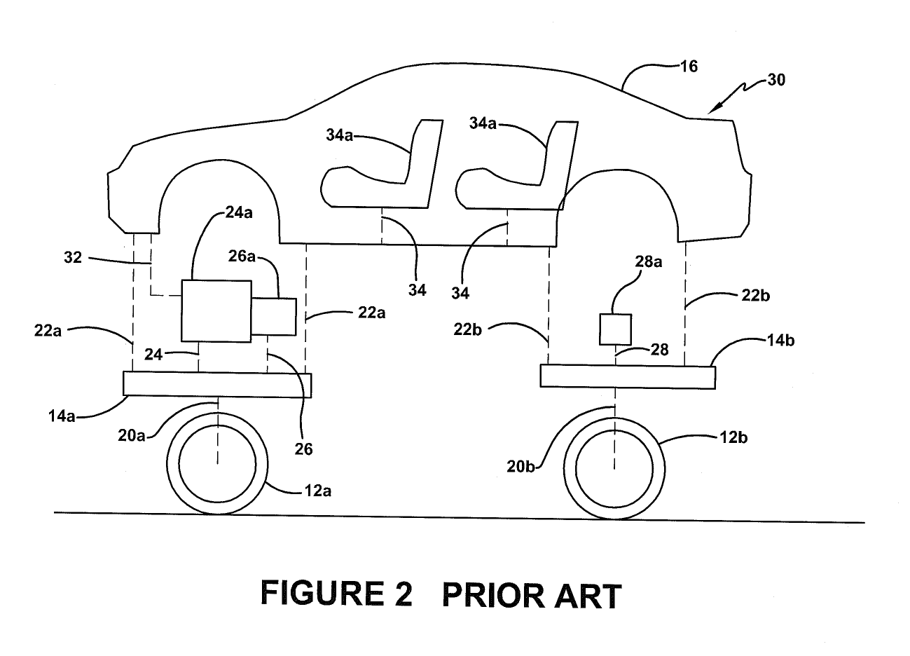

As shown in FIG. 2, subframes 14a, 14b are typically part of a vibration isolation system in conventional unibody designs. By including the floating interior sled 60, the subframes 54a, 54b can be simplified. Subframe design generally requires trade-offs between weight, cost, geometric complexities impacting manufacturability and vibrational mode control. With the interior sled 60 design and vibrational mode control constraints can be lessened since the interior of the cabin has been isolated from the body 56. The subframes 54a, 54b shown in FIG. 4 can thus be greatly simplified.

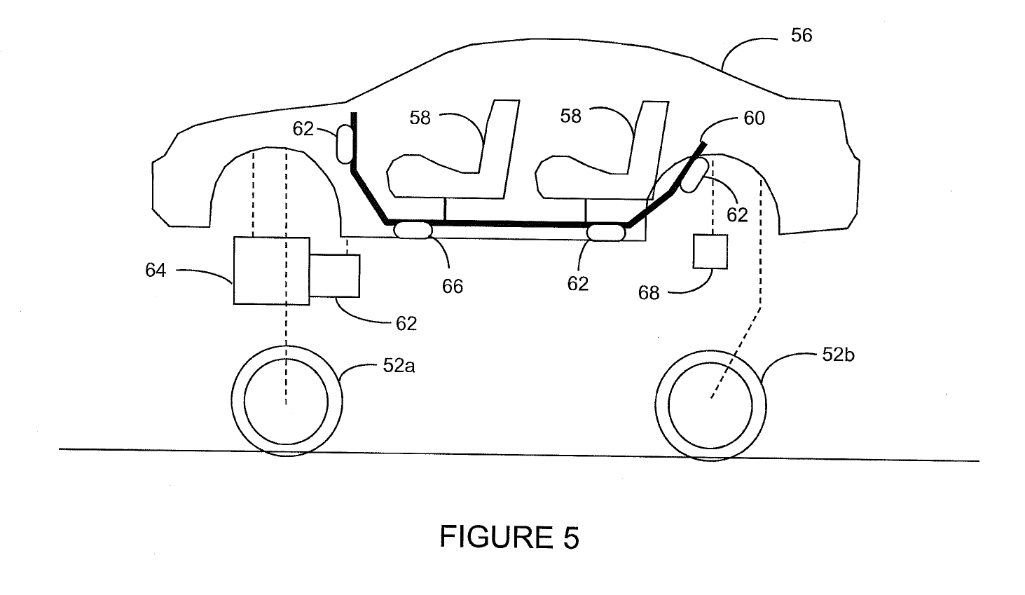

FIG. 5 shows a modified isolation scheme for a floating interior in accordance with an alternative exemplary embodiment. In addition to simplifying the subframes 54a, 54b as described above, the use of the interior sled 60 can provide for the elimination of the subframes 54a, 54b. This enables the engine 64, the transmission 66, and the drive axle 68 to be directly attached to the vehicle body 56 with respective support structures (indicated as dashed lines in FIG. 5). Similarly, a wheel-body load absorption path is defined between the vehicle wheels 52a, 52b and the body (as indicated by dashed line in FIG. 5). Such attachments to the body could conceivably be made without intervening isolation components.

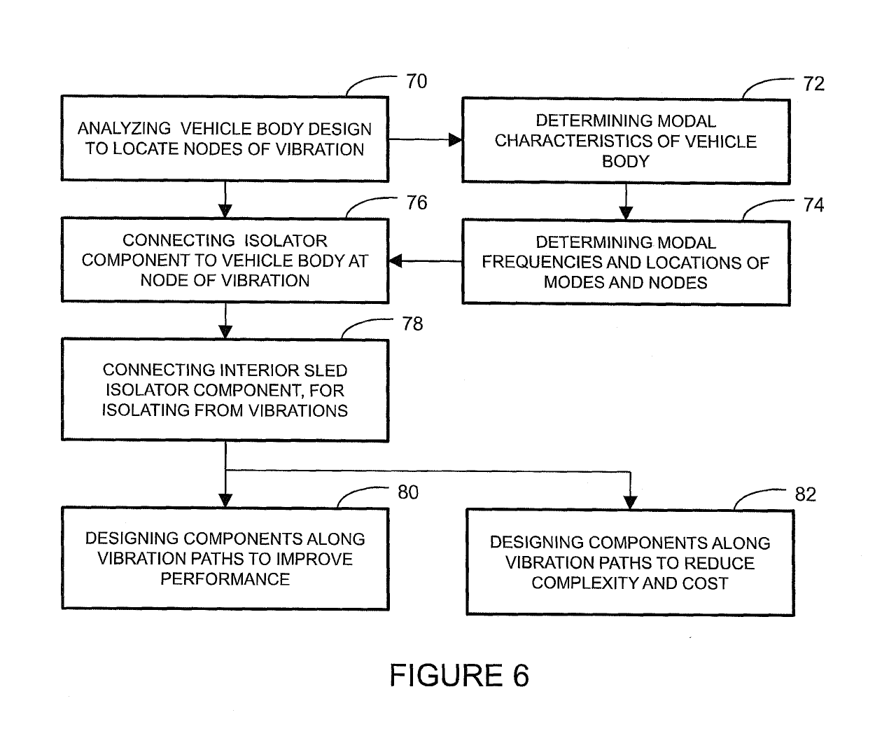

The flow chart of FIG. 6 depicts a method of constructing a vibration-isolated vehicle in accordance with an exemplary embodiment. At 70, the vehicle body design is analyzed to locate vibrational nodes. The analysis can be performed based on other aspects of the principal vibrations. For example, as alternatively indicated at 72, the analysis can determine modal characteristics of the vehicle body. As indicated at 74, this can entail determining modal frequencies and locations of modes and nodes of various body vibrations. The analysis can include computer modeling and can also include testing of fabricated vehicle body parts.

The vibration isolation system can be designed to take advantage of the above-described modal information. At 76, one or more vibration isolators are connected to the vehicle body at locations corresponding to vibrational nodes where out-of-plane motions of the body vibration are minimal. At 78, an interior sled is connected to the vibrational isolators to define a vehicle interior occupant area isolating vehicle occupants from vibrations transmitted throughout the vehicle.

The above method beneficially provides for identification and selection of particular vibration nodes of interest based on targeted frequency ranges. Additionally, the vibration isolators can be designed to attenuate other frequency ranges not associated with the node to which they are attached. In this way, two levels of attenuation can be accomplished by using the geometry of the sled-to-body connection and the design of the mounting system itself.

The above method enables vibration isolation considerations to be separated from other design constraints. In this way, as indicated at 80, vehicle components along vibration paths can be designed for improved performance rather than for isolating vibration. Further, as indicated at 82, vehicle components along vibration paths can be designed to reduce complexity and cost rather than for isolating vibration. In this manner, design efficiency is improved and cost benefits are obtained using the above method.

The above-described method and apparatus enables simplified part design and improved performance. The design constraints associated with vibration isolation and low frequency motions can be decoupled from performance considerations, thereby improving efficiency and other economic factors. This is particularly applicable for a unibody construction typically used in modern passenger cars.

It will be apparent to those skilled in the art that changes and modifications may be made to the above methods and apparatuses without departing from the general scope of this invention. It is intended to include all such modifications and alterations in so far as they come within the scope of the appended claims or the equivalents thereof.

What is claimed is:

1. A vehicle comprising:
a vehicle body defining an interior for retaining vehicle occupants, the vehicle body arranged to receive vibrations transmitted throughout the vehicle;
a plurality of seats for supporting vehicle occupants;
a sled structure located within the body interior and including a floor portion to which the seats are mounted; and
at least one sled isolator connected to the sled structure and to the body, the sled isolator having a damping property such that the sled structure and seats are isolated from the body vibrations.

2. The vehicle of claim 1, wherein the vehicle comprises at least one frame portion through which the vibrations are transmitted.

3. The vehicle of claim 1, wherein the interior sled includes at least one wall portion extending from an end of the floor portion.

4. The vehicle of claim 3, wherein the interior sled includes a front wall portion and a rear wall portion respectively extending from front and rear ends of the floor wall portion.

5. The vehicle of claim 1, wherein the at least one sled isolator is placed at a node of a body vibration frequency, to isolate the vehicle occupants from the body vibration frequency.

6. The vehicle of claim 1, wherein the at least one sled isolator is adapted to attenuate frequency ranges outside a body vibration frequency.

7. The vehicle of claim 1, wherein the vehicle body has a unibody construction.

8. The vehicle of claim 3, wherein the at least one sled isolator includes at least one sled isolator connected to the floor portion and at least one sled isolator connected to each wall portion.

9. The vehicle of claim 7, wherein the vehicle includes at least one vibration-producing vehicle component selected from the group consisting of a subframe, a vehicle wheel, an engine, a transmission, and a drive axle.

10. The vehicle of claim 1, wherein the at least one sled isolator is connected to the vehicle body at a location selected from the group consisting of a floor area, a B-pillar base, a rear cross member area, and a firewall of the body.

11. A vibration-isolation system for a vehicle comprising:
an interior sled having a floor portion defining a seat-mounting area adapted to support a plurality of seats, the interior sled located within an interior defined by a vehicle body; and
at least one sled isolator connected to the interior sled and to the vehicle body, the sled isolator having a damping property for isolating the interior sled from vibrations of the vehicle body.

12. The vibration-isolation system of claim 11, wherein the interior sled includes at least one wall portion extending from an end of the floor portion.

13. The vibration-isolation system of claim 12, wherein the interior sled includes a front wall portion and a rear wall portion respectively extending from front and rear ends of the interior sled.

14. The vibration-isolation system of claim 11, wherein the at least one sled isolator is connected from the interior sled to the vehicle body at a node of a body vibration frequency so as to isolate the body vibration frequency.

15. The vibration-isolation system of claim 11, wherein the at least one sled isolator is connected from the interior sled to the vehicle body at a location selected from the group consisting of a floor area, a B-pillar base, a rear cross-member area, and a firewall of the body.

16. The vibration-isolation system of claim 11, wherein the interior sled comprises a mounting structure adapted to provide an additional stroke to attenuate high-g spikes.

17. The vibration-isolation system of claim 16, wherein the additional stroke of the mounting structure comprises at least one of a longitudinal stroke or a lateral stroke with respect to the vehicle body.

18. A method of constructing a vibration-isolated vehicle comprising:
analyzing a vehicle body design to locate nodes of vibration;
connecting at least one isolator component to the vehicle body at a location corresponding to at least one of the nodes of vibration;
connecting an interior sled adapted to support passenger seats to the at least one isolator component so as to isolate the interior sled and passenger seats supported on the sled from vibrations of the vehicle body.

19. The method of claim 17, wherein the analyzing further comprises determining modal characteristics of the vehicle body.

20. The method of claim 18, wherein the determining modal characteristics comprises determining modal frequencies and locations of modes and nodes of body vibration.
